(19) United States
(12) Patent Application Publication
(10) Pub. No.: US 2026/0307274 A1
(43) Pub. Date: Oct. 8, 2026

(54) ADHESIVE-BASED ROBOT GRIPPER

(71) Applicant: PICKOMMERCE AI ROBOTICS LTD, Meitar (IL)

(72) Inventors: Amir SHAPIRO, Meitar (IL); Gal LEVY, Petach Tikva (IL); Kfir NISSIM, Moshav Sal'it (IL)

(21) Appl. No.: 19/108,359

(22) PCT Filed: Aug. 23, 2023
(86) PCT No.: PCT/IL2023/050896

§ 371 Date: Mar. 3, 2025

(51) Int. Cl. B25J 15/00; B25J 19/00; B65H 23/18

(52) U.S. Cl. CPC B25J 15/008; B25J 19/0025; B65H 23/1806; B65H 2701/377

(57) ABSTRACT

The invention relates to an adhesive-based tool gripper for a robot, comprising: (a) a supplying axle configured to mount a supplying bobbin of adhesive tape; (b) a receiving axle configured to mount a tape-receiving bobbin; a bottom pad; (c) a tape course within the tool gripper beginning at said supplying bobbin, passing below said bottom pad, while an adhesive side of the tape faces down, and ending at said receiving bobbin; and a tape advance mechanism configured to advance the tape, thereby refreshing a tape section below said bottom pad.

### FIELD OF THE INVENTION

The invention relates to the field of mechanical grippers used by robots. The invention particularly relates to a robot's adhesive-based gripper configured for repeated multi-gripping operations using a single adhesive band.

### BACKGROUND OF THE INVENTION

The volume of article deliveries purchased via e-commerce has increased dramatically in recent years. The great variety of articles, their different dimensions, weights, and shapes, and the necessity to meet minimal delivery times caused enterprises to increase their workforce significantly. However, the ability of a skilled worker to collect and pack a large order is limited. The rapid increase in shipment volume no longer allows the use of only humans for packaging. While robots have already been applied to meet the increased demands, their reliability is far from satisfactory, particularly given the limitation of robot grippers to cope with the large variety of weight, shapes, dimensions, varied article rigidities, and orientation of each specific article relative to the robot's arm.

Two types of robot grippers are primarily used in today's shipment (e-commerce) industry: (a) mechanical (“fingers,” or parallel) grippers; and (b) vacuum-type grippers. Mechanical grippers require an accurate real-time consideration of the grasping points, which must also be adapted for each product, and its orientation at the time of grasping. This very challenging task has not been reliably met yet for all products without damaging gripping failures, given the significant diversion of weight, shapes, dimensions, rigidity, the delicacy of the product's material, and orientation.

The vacuum-type gripper uses a vacuum suction cup (usually made of soft material) and a vacuum pump to adhere to an object using a vacuum force. This force is directly proportional to the vacuum cup's surface area and the pressure difference between the vacuum cup's interior and the ambient pressure. The vacuum gripper applies a pulling force-therefore, a single vacuum gripper is sufficient to lift and displace objects. Vacuum grippers are particularly popular in “pick and place” assignments; however, they ideally require a smooth, relatively flat contact area to create vacuum conditions. Therefore, vacuum-type grippers are inefficient for grasping porous objects or objects with textured surfaces (e.g., a fabric surface). Moreover, some soft materials (such as plastic) may deform during suction. Also, the vacuum quality decreases significantly in cases where the vacuum cup is not correctly placed over the article. Vacuum grippers are also unsuitable for lifting or pulling heavy objects, mainly when a small area is available for suction. In addition, vacuum grippers cannot be effectively used in, for example, aerospace conditions, where the ambient pressure is zero.

Prior art robots apply imaging techniques and artificial intelligence with pre-training to properly operate the robot and enable it to operate the gripper optimally. The pre-training stage teaches the robot to recognize the various products irrespective of the specific product orientation and assign the best gripping orientation and position at the product for optimal gripping. Following the gripping, some robots can optimally position the article within a receiving box designed to contain a plurality of articles.

Given the difficulty of applying a single gripper and a single gripper type to various articles, the prior art has disclosed multi-type gripping robots that can select and replace the gripper (at the tip of the robot's arm) depending on the characteristics of the given article. More specifically, the robot's arm is configured to select, mount, and use a gripper most suitable to the article and task.

WO 2020/240542 by the same applicant discloses various adhesive-based robots, grippers, and stickers for use by the grippers. The WO 2020/240542 system suffers from several drawbacks, as follows: (a) The structure of the gripper is relatively complicated; and (b) The system utilizes individual stickers and has to collect a new sticker for each article before each gripping; (c) Following the gripping operation, the gripper leaves the sticker attached to the product (or to the product's container), while the product (or container) and the sticker attached to it are together dispatched to the final consumer. While this feature may be advantageous in some cases (as the sticker may include, for example, a barcode enabling tracking of the product), this attachment is considered redundant in other cases; and (d) A cartridge of separate stickers needs a frequent replacement, following a small number of gripping operations. While the cost of each sticker is relatively low (several US cents), it is still a relatively high cost for some cheap articles delivered by today's e-commerce.

It is an object of the invention to provide an adhesive-based gripper that does not require operation with individual stickers.

Another object of the invention is to provide an adhesive-based gripper that does not involve leaving a sticker attached to the article following each gripping operation.

Still, another object of the invention is to reduce the cost of each gripping operation compared to prior art adhesive-based grippers.

It is still another object of the invention to provide a more efficient and reliable gripper for some types of articles compared to prior art grippers.

It is still another object of the invention to provide the gripper in a simple, compact, and low-cost structure.

Another object of the invention is to provide a gripper suitable for operation within a gripper-selecting type robot (namely, a robot configured to select and replace the gripper used, depending on the specific article and task).

Other objects and advantages of the invention will become apparent as the description proceeds.

### SUMMARY OF THE INVENTION

The invention relates to an adhesive-based tool gripper for a robot, comprising: (a) a supplying axle configured to mount a supplying bobbin of adhesive tape; (b) a receiving axle configured to mount a tape-receiving bobbin;
a bottom pad; (c) a tape course within the tool gripper beginning at said supplying bobbin, passing below said bottom pad, while an adhesive side of the tape faces down, and ending at said receiving bobbin; and a tape advance mechanism configured to advance the tape, thereby refreshing a tape section below said bottom pad.

In an embodiment of the invention, the adhesive-based tool gripper further comprising a disconnecting mechanism configured to push an article attached to said tape section away from the bottom pad.

In an embodiment of the invention, the adhesive-based tool gripper further comprising a locking mechanism for the receiving axle.

In an embodiment of the invention, the adhesive-based tool gripper further comprising a locking mechanism for both the receiving axle and the supplying axle.

In an embodiment of the invention, the adhesive-based tool gripper further comprising an adapter that is configured for attachment to a robot arm;

In an embodiment of the invention, said tape-advance mechanism is selected from a servo motor or a rotating piston.

In an embodiment of the invention, said disconnecting mechanism comprising: (a) a moveable peripheral frame enveloping said bottom pad; and (b) one or more side pistons configured to either push the peripheral frame distally—in a direction away from an arm of the robot, or retract it proximally.

In an embodiment of the invention, said disconnecting mechanism comprising: (a) a stationary peripheral frame enveloping said bottom pad; and (b) a central piston configured to either push the bottom pad distally—in a direction away from an arm of the robot, or retract it proximally.

In an embodiment of the invention, said side pistons are selected from linear pistons, rotary pistons, linear actuators or linear motors, spring-retracted pistons, or air-driven pistons.

In an embodiment of the invention, the adhesive-based tool gripper further comprising a tape tightening mechanism configured to tighten the bottom pad against said tape section.

In an embodiment of the invention, said tape tightening mechanism comprising a central piston, configured to push the bottom pad distally, at a direction away from an arm of the robot to which the gripper is installed.

In an embodiment of the invention, said central piston is a spring retracted piston, or a passive spring.

In an embodiment of the invention, said central piston is attached to a locking mechanism configured to lock a rotation of said supplying axle, simultaneously with said distal push of the bottom pad.

In an embodiment of the invention, said adapter is configured to receive controlled air supply and/or electricity from a robot's arm and is further configured to convey said air and/or electricity to components within the adhesive tool gripper.

In an embodiment of the invention, said air and/or electricity are controlled by a robot's controller.

In an embodiment of the invention, said advance of the tape is further used to disconnect an article attached to the tape.

The invention also relates to a method for operating an adhesive-based robot controller, comprising: (a) providing an adhesive-based tool gripper comprising a casing; (b) providing a bottom pad within said casing; (c) further providing within the casing a supplying tape axle and a receiving tape axle; (d) mounting on each said axles a supplying tape bobbin and a receiving tape bobbin, respectively, and positioning the adhesive tape such that it begins in said supplying tape bobbin, passes below said bottom pad, and ends at said receiving tape bobbin; (e) joining the tool gripper to a robot's arm; (f) directing the arm towards an article, attaching a tape section below said bottom pad to the article, lifting the article, positioning the article at a desired location, and releasing the article; and (g) advancing the tape to locate a refreshed tape section below said bottom pad and repeating the procedure from the directing step.

In an embodiment of the invention, the method further comprising the replacement of the supplying tape bobbin upon reaching an end of the tape.

### BRIEF DESCRIPTION OF THE DRAWINGS

In the drawings:

FIG. 1 generally shows a general structure of a prior art articulated robot commonly used for gripping and lifting objects;

FIG. 2 shows the robot of FIG. 1 attached to a tool changer;

FIG. 3 shows a set of gripper tools positioned on a tool's stand;

FIG. 4 shows a robot attached to a robot tool;

FIG. 5a shows a gripper in a side view while illustrating the route of the continuous adhesive tape placed within the gripper;

FIGS. 5b, 5e, and 5f show the gripper of the invention in various front perspective views;

FIG. 5c shows the internal section of the gripper while eliminating several parts for better visual clarity;

FIG. 5d shows the gripper of the invention from a bottom-perspective view;

FIGS. 5g, 5h, and 5i show the process of attaching the gripper to an article (a shoe in this case);

FIG. 6 illustrates in a flow diagram form a general procedure for operating the gripper of the invention;

FIG. 7 illustrates in a block diagram form the general structure of the gripper of the invention;

FIG. 8 illustrates in a flow diagram form a general procedure for operating a robot arm with the gripper of the invention;

FIG. 9 generally illustrates the structure of a second embodiment of a gripper, according to an embodiment of the invention;

FIG. 10 shows several of the articles successfully lifted by the gripper of the invention;

FIGS. 11a-11f show the gripper of the invention during a test while being attached to a robot's arm and while lifting various types of articles having various weights and shapes;

FIGS. 12a and 12b show the structure of the gripper of the invention, according to a third embodiment, in extended and retracted states, respectively;

FIGS. 12c and 12d show the structure of the gripper of the invention, according to the third embodiment, in extended and retracted states, respectively, while including adhesive tape; and

FIG. 12e is a graph showing the current flow through the motor of the gripper of the invention, as measured in a test.

### DETAILED DESCRIPTION OF PREFERRED EMBODIMENTS

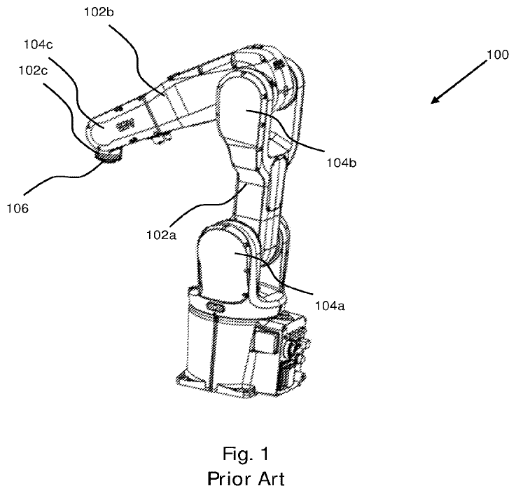

A general structure of an articulated robot 100, commonly used for gripping and lifting objects, is shown in FIG. 1 (without a gripper attached). The robot includes several arm sections 102 (three sections 102a-102c are shown, as an example) and several rotational joints 104, each connecting between two adjacent arm sections (three joints are shown, as an example). Each joint is typically provided with a controllable servo motor (not shown) configured to rotate one arm-section 102 relative to the adjacent section. This common structure of FIG. 1 gives the robot's arm six degrees of freedom (however, more or fewer degrees of freedom are also common). Robot 100 may include a single type (non-replaceable) gripper integrally connected to its arm. Alternatively, the robot may be connectable to a tool (e.g., gripper) changer (hereinafter, also referred to as “gripper changer”) for selecting an optimal gripper to perform the specific gripping task at hand. One or more imaging units (or other sensors) are commonly positioned on the robot's arm to provide the robot controller (not shown) with a continuous image of the product surroundings. Using the image, the robot controller continuously determines and corrects its gripping orientation relative to the manipulated article during the robot operation. The robot controller manipulates the arm utilizing the servo motors and gripper to grip (by the gripper, not shown in FIG. 1) a target object, lift it, and move it to the desired location. Various robot-controlling algorithms are well-known and commonly used within the robot's controller.

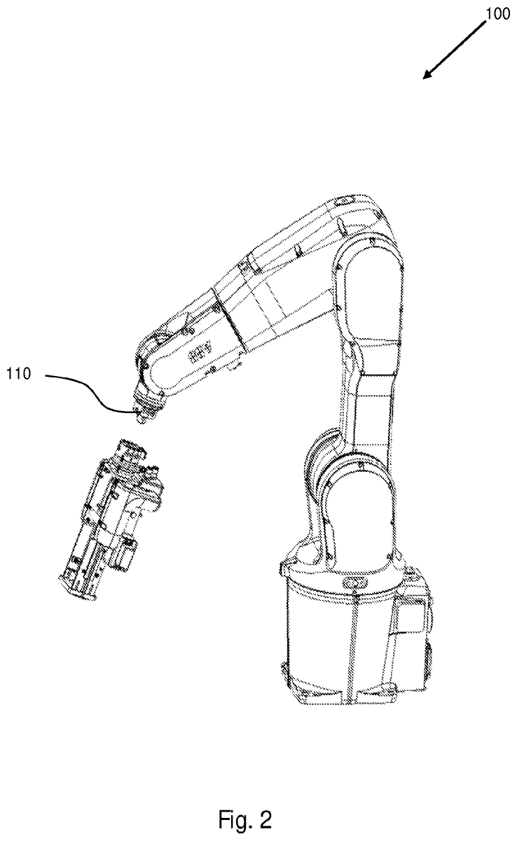

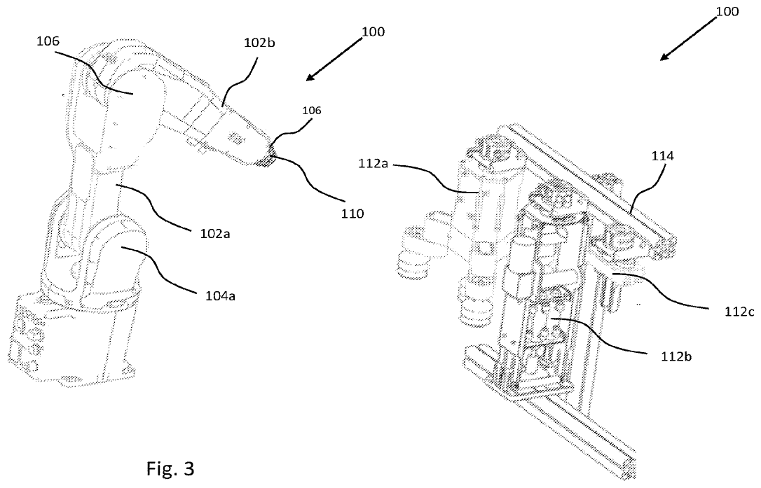

As discussed, robot 100 may include a single (non-replaceable) gripper as an integral part of the arm or be configured as connectable (at the arm's tip) to a tool changer used for selecting an optimal gripper (or other tools that are beyond the invention's scope) from among a given set of gripper tools. The arm-gripper joining is accomplished by utilizing an adapter mounted on each tool. FIG. 2 shows the robot 100 of FIG. 1 joined to a tool changer 110. As shown in FIG. 3, a set of gripper tools 112a-112c is positioned on a stand 114. In this specific case, the gripper set 112a-1122c includes a vacuum gripper 112a, the adhesive-based gripper 112b of the invention (discussed in more detail below), and a finger-based gripper 112c. Other types of grippers (or tools) known in the art may also be included within set 112. Based on analyzing the given robot's task and article characteristics (weight, shape, dimensions, orientation, etc.), robot 100 is configured to autonomously select the most suitable gripper tool 112 from among the given grippers' set and join the selected tool to the grip changer 110 located at the arm's tip 106.

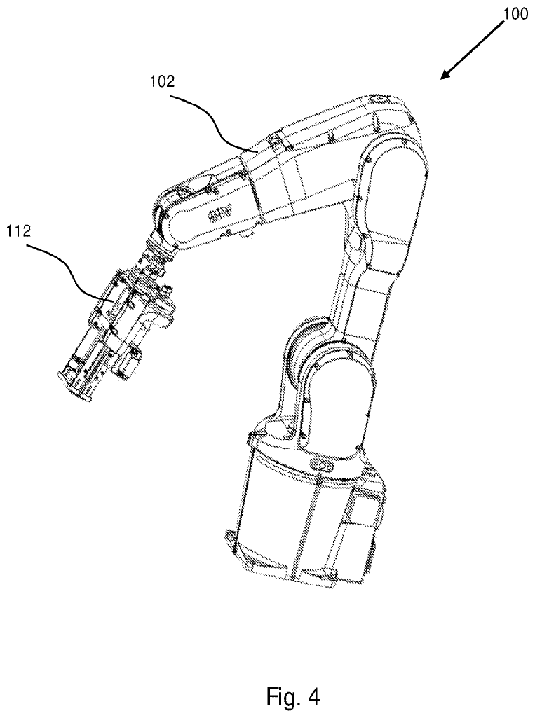

While the finger-type gripper 112c (FIG. 3) can operate solely with electrical signals, the prior art vacuum gripper 112a (ending with one or more vacuum cups) requires an air (vacuum) supply. Various adaptations are made within arm 102, the robot controller, and the gripper to support multi-gripper (selectable) operations. For example, in the multi-gripper type robot, the arm 102 and tool changer 110 include a first port for supplying electrical control signals from the arm to the tool changer 110 and a second air-type port for providing a vacuum. Several tools (such as finger gripper 112c) may only receive and use electrical signals. Other tools, such as the vacuum gripper 112a, include the vacuum and the electrical signal ports. In any case, multi-gripper robots and their tool changer 110 are configured to support air supply and electrical signals conveyed from the arm to the tool changer and from the tool changer to the gripper tool. As discussed hereinafter, in some embodiments, the adhesive-based gripper of the present invention similarly utilizes electrical and air-type ports for its operation. FIG. 4 shows robot 100 joined to one selected robot tool 112.

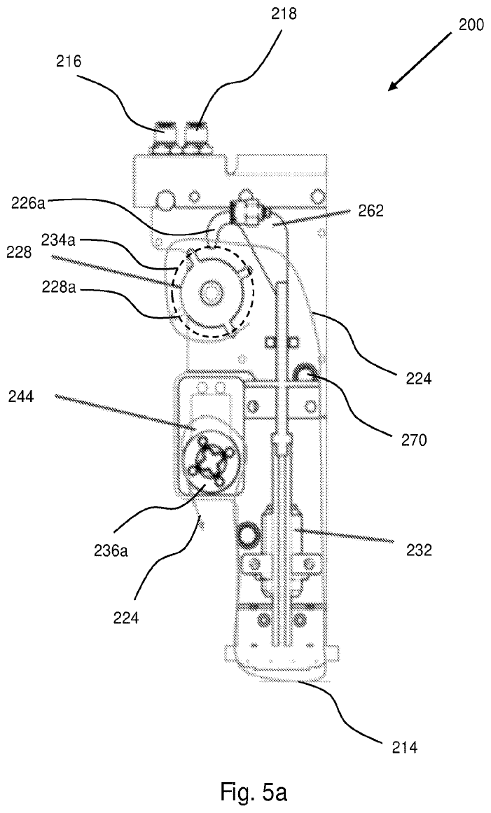

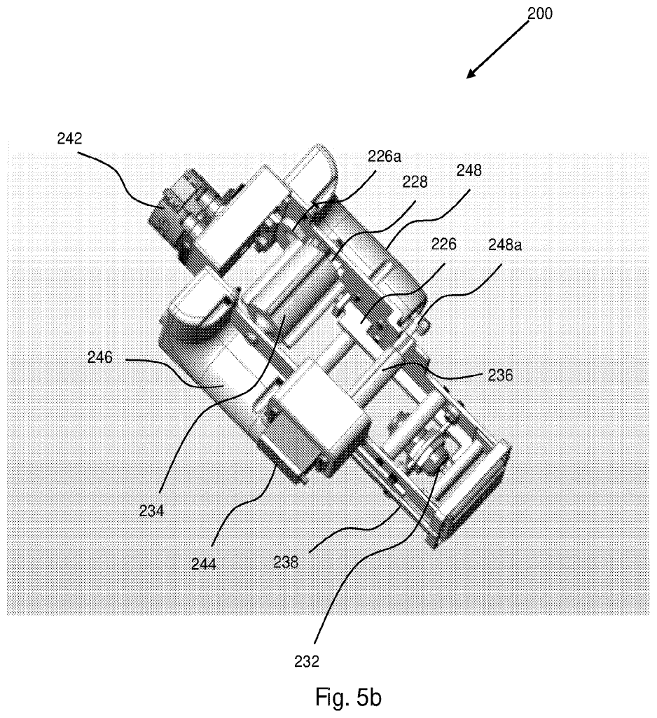

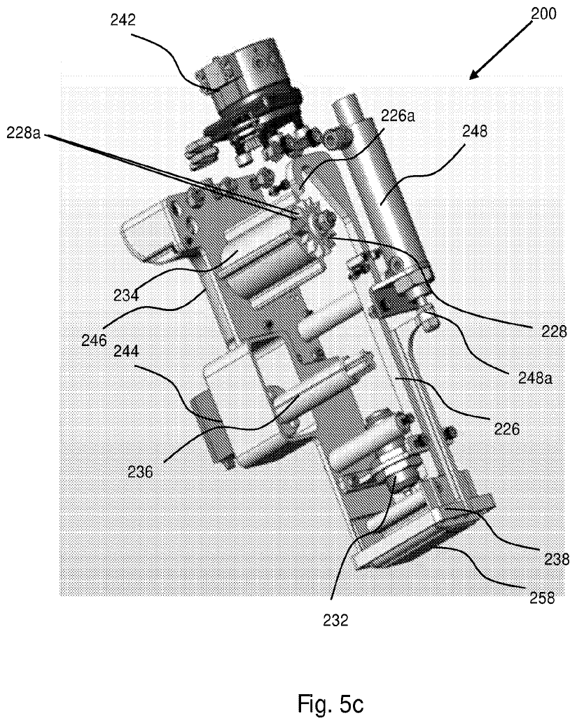

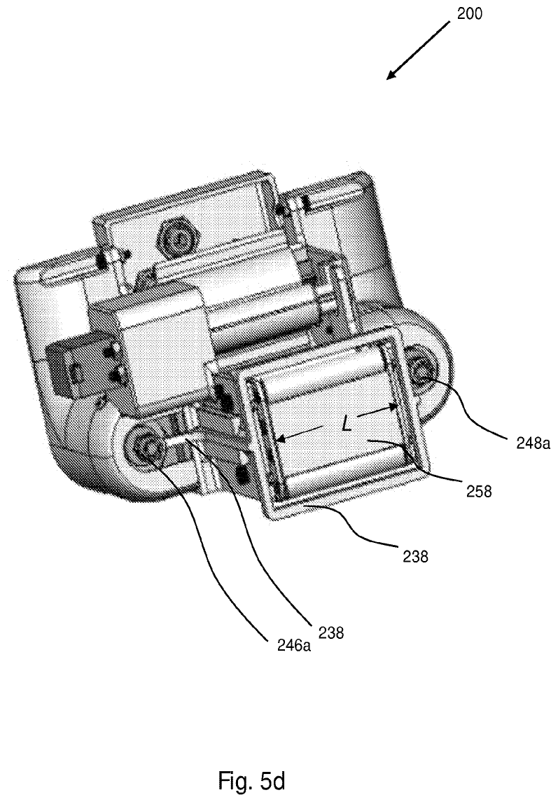

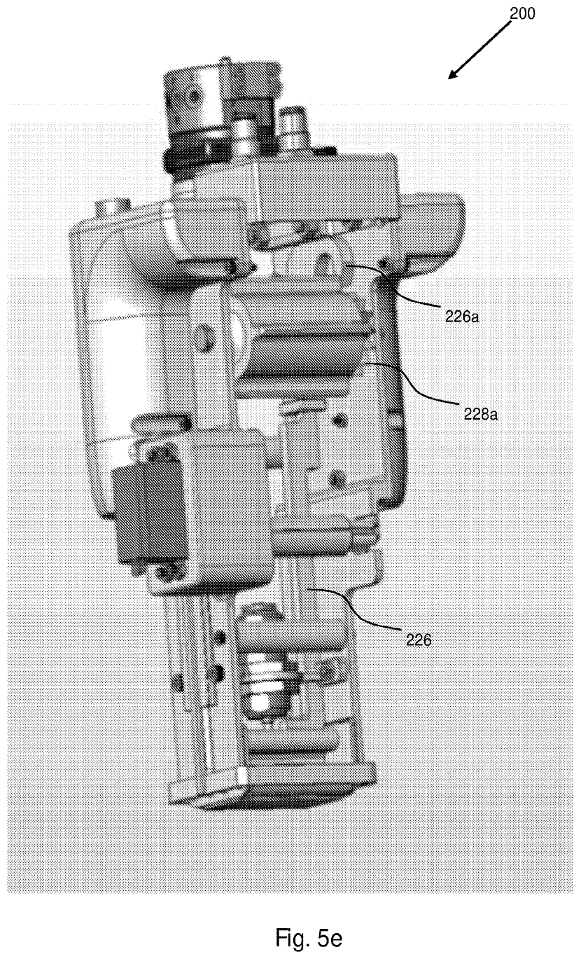

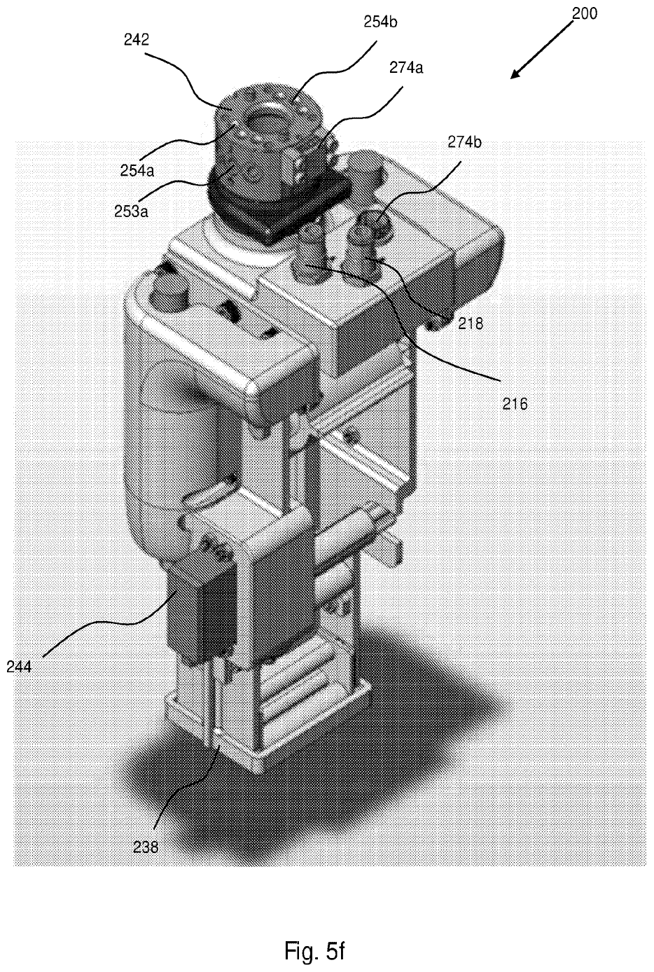

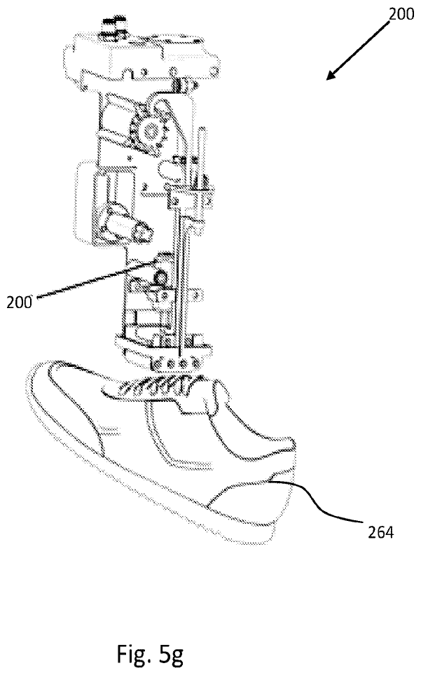

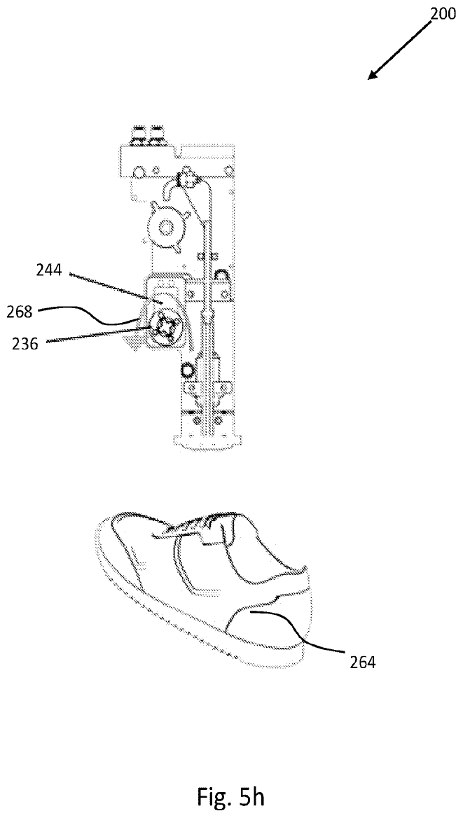

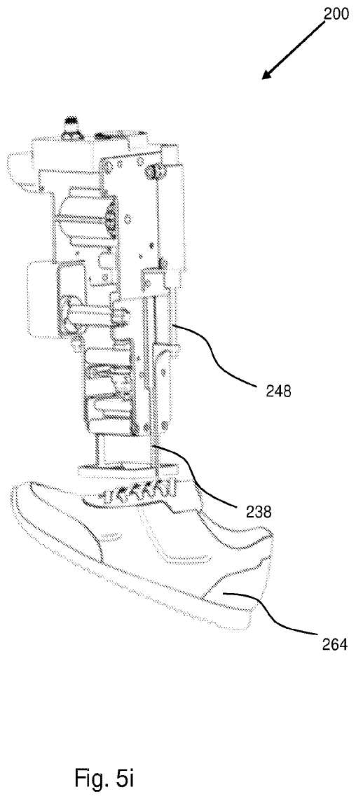

FIGS. 5a to 5i show the general structure of the adhesive-type gripper of the present invention, according to a first embodiment. FIG. 5a shows the gripper in a side view while illustrating the route of the continuous adhesive tape mounted within the gripper. FIGS. 5b, 5e, and 5f show the gripper in various front perspective views. FIG. 5c shows the internal of the gripper while eliminating several parts for better visual clarity. FIG. 5d shows the gripper from a bottom-perspective view. FIGS. 5g, 5h, and 5i show the process of attaching the gripper to an article (a shoe in this case).

The general structure of the adhesive-based gripper 200 of the invention is shown in FIGS. 5a, 5b, and 5c. The gripper includes a supplying tape axle 234 and a receiving tape axle 236 (FIG. 5b). Each of these two axles is configured to receive (in a rotational bobbin-axle lock form) a tape bobbin, 234a, and 236a, respectively. Initially, the new (supplying) tape bobbin 236a is placed over the supplying axle 234, while an (initially) empty (receiving) bobbin is placed over the receiving axle 236. From the supplying tape bobbin 234a, and as shown in FIG. 5a, the edge of tape 224 is pulled and mounted within a designated tape route, passing through a bottom pad 258 (FIGS. 5c and 5d) and ending at the receiving tape bobbin 236a. Along this tape route, the tape may pass through one or more free rotating pulleys 270 (FIG. 5a), used to ease the tape's movement by reducing friction. While passing along pad 258, the adhesive side of the tape faces downwards (outwards). The receiving axle 236 is driven by servo motor 244 to advance each time a tape section having the length L (or longer), L is the length of pad 258 (shown in FIG. 5d). The gripper side close to the arm is referred to as the “proximal.” The side away from the arm is referred to as the “distal”.

As best seen in FIG. 5c, teeth wheel 228 is rigidly and coaxially attached to the side of supplying axle 234. Locking tooth 226a, a part of movable locking arm 226, is configured to engage, when necessary, in between two teeth 228a of the teeth wheel, and when this engagement occurs, the rotation of axle 234 is prevented. More specifically, the locking arm moves between a locking (downward) state, where it prevents the rotation of the supplying axle 234, and between a non-locking (upward) where the supplying axle 234 is free to rotate. Central piston 232, attached to the locking arm 226, moves arm 226 between these two states. The central piston 232 is also attached to bottom pad 258 to perform two functions simultaneously. In the (proximally) retracted state of piston 232, the locking arm 226 is in its unlocking state, and the bottom pad 258 is in its retracted state, as shown in FIG. and 5c. Therefore, in the retracted state, the servo motor 244 can advance the tape 214; each advance refreshes the adhesivity of the tape below pad 258. In the (distally) extended state of the central piston 232, the piston pushes the locking arm 226 downward, thereby locking the supplying axle 234. Simultaneously, the central piston distally pushes the bottom pad 258 downward towards tape 214 (FIG. 5a), causing tightening of the tape. The mechanism for causing tightening of the tape, such as, the central piston, and the pad, is referred as “the tightening mechanism”. Many other alternatives may be used to cary out this function.

Gripper 200 further includes two side pistons, left piston 246 and right piston 248, respectively. The left and right pistons 246 and 248 are connected to the left and right sides of the peripheral frame 238 (the peripheral frame 238 preferably includes two upwards extensions to which the pistons are connected, as shown). The two pistons are air-fed simultaneously, typically from the same air inlet (port). In the retracted state of the side pistons, frame 238 is maintained in its retracted state, as shown in FIGS. 5c and 5d. During the active state of the gripper, the two side pistons are at their retracted state, enabling contact between the bottom pad and the top side of tape 214. More specifically, during the active state, the gripper causes a downward force to be applied by the bottom pad 258 on tape 214. When the tape contacts article 264, it is adhesively attached to the article, as shown in FIG. 5g, and can lift and move it to the desired location.

The activation of the two side pistons to their distally extended state pushes the peripheral frame 238 downwards. As shown in FIG. 5i, this downward movement of the peripheral frame 258 distances the bottom pad 258 and the tape 214 from article 264, disconnecting the article from the adhesive tape 214. Following this disconnection (typically after bringing the article to the desired location), the two side pistons and the central piston may return to their retracted (proximal) state. Then, the servo motor 244 may again advance the tape 214 to provide a refreshed tape section below pad 258, thereby preparing the gripper 200 for the next article lift.

To summarize, the gripper 200 of the invention has three states, as follows:
a. An initial state where the three pistons are at their retracted state and where the supplying axle 234 is unlocked, enabling the servo motor to refresh the adhesive section of tape 214 below the bottom pad;
b. An active state where the central piston is in its distally extended position, pushing the bottom pad downward and locking the supplying axle 234. In this state, the gripper is ready to grip an article; and
c. A disconnecting state, where the two side pistons are at their distally extended position, distancing and disconnecting the pad 258 and tape 214 from the attached article.

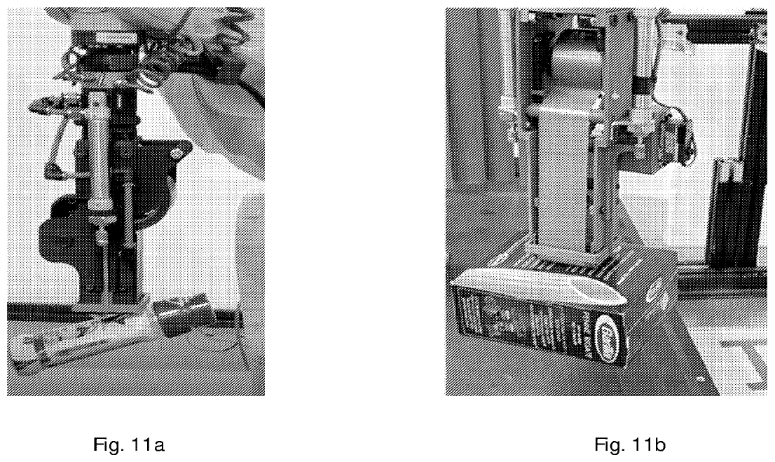

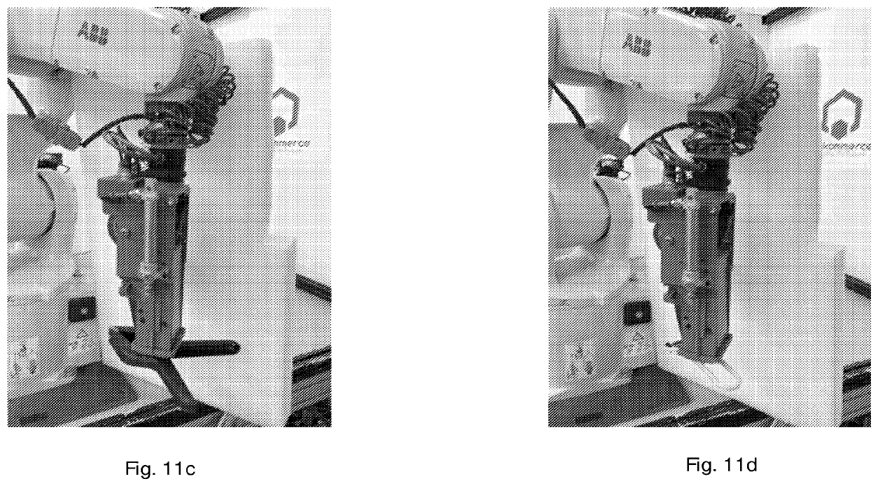

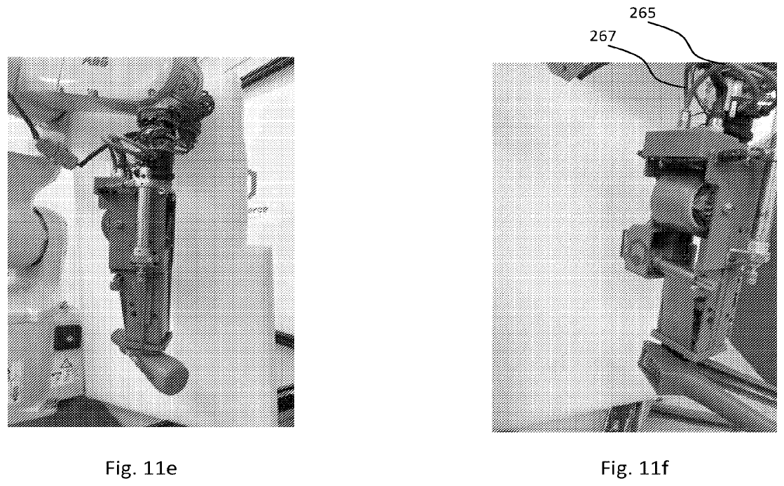

Preferably, the three pistons are air operated via respective air inlets 216 and 218 located at the proximal side of the gripper, respectively (FIG. 5f). In one embodiment, the air for the central piston 232 is provided via inlet 216. The air for the two side pistons 246 and 248 is simultaneously supplied from air inlet 218. Preferably, each piston includes a return spring, which returns the piston to its retracted (proximal) state upon cessation of air pressure via the respective air inlet. Moreover, a single piston (rather than two separate pistons) may be used to drive the peripheral frame. Moreover, various pistons (other than air pistons) may be used. Typically, the air from the arm to the gripper is supplied via holes 254a, 254b, . . . 254n at the adapter 242. The air from the adapter to the air inlets is supplied via bridging tubes 265 and 267 (shown in FIG. 11f), bridging between adapter outlets 253 and air inlets 216 and 218, respectively. Other electricity signals from the arm to the gripper are supplied via adapter 242 (FIG. (5b).

As noted, the central piston of FIGS. 5a-5i has two states, a proximal (retracted) state in which the pad is somewhat remote from the tape, and an extended (distal) state in which the pad is pushed against the tape 214. The central piston may be somewhat “elastic”, such that while it is in its extended state, it may slightly move to the proximal direction upon impact with the article. This feature may prevent the crush of the article at the time of impact. In still another embodiment, the central piston may be replaced by a passive spring. In that case, the spring may keep the pad continuously at its distal position, while at the time of impact, the pad may push the spring to the proximal direction, thereby absorbing and reducing the impact with the article.

The supply of electrical signals (for example, to activate servo motor 244) from the robot's arm to (typically standard) adapter 242 is provided via the first connector 274a. Then, bridging wires connect between the first connector 274a and second connector 274b (located on the body of the gripper) to lead the signals to respective components within gripper 200. Alternatively, a single connector on the adapter 242 may suffice, where the wires connect the signals directly to the internal components. Given the simple structure of the invention's gripper, there is no necessity to use a controller within the gripper. The gripper is entirely controlled by the robot's controller (not shown).

FIGS. 5a-5i show one example of the gripper of the invention, operating with a continuous tape 214. Various adaptations and modifications within the invention's scope can be made. For example, one or more linear motors or solenoids may be used instead of pistons. Furthermore, the central piston may be replaced by a spring. A rotating piston may replace the servo motor. Any mechanism configured to push the article away from the bottom pad (and tape below it) may replace the peripheral frame. In one embodiment, a gear may be used between the peripheral frame and the central pad, so either the pad or the peripheral frame may be disposed more distally at any given time.

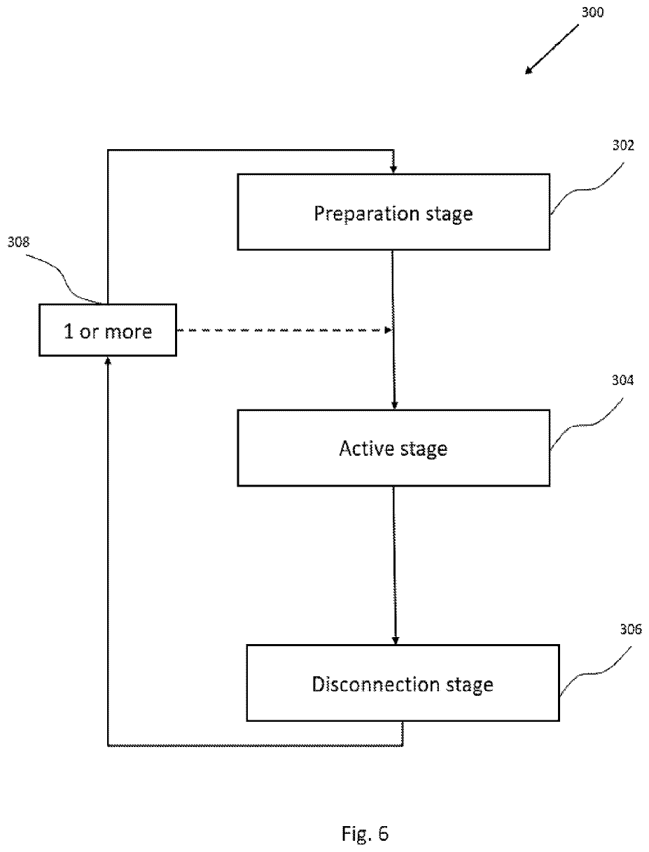

FIG. 6 illustrates a general procedure 600 for operating the gripper 200 of the invention in a flow diagram. In the preparation stage 302, a refreshed adhesive tape is positioned below pad 258 (utilizing servo motor 244). Next, in the active stage 304, the central piston is activated to tighten the tape 214. At this stage, the gripper is ready for attachment (i.e., ready to grip) to the target article. Once the gripping occurs, the article can be lifted and brought to the target position. Next, the procedure continues to the disconnection stage 306, where the two side pistons 246 and 248 are (distally) activated to push the peripheral frame 238, disconnecting the article. Following the disconnecting stage, the procedure generally returns to preparation stage 302 (i.e., “1” in stage 308), where the tape below pad 258 is refreshed. In some cases, however, when the adhesive layer on tape 214 is strong enough, a single tape section may be used several times (for example, twice or three times) before tape refreshment becomes necessary. In this case, the procedure may skip the preparation stage 302.

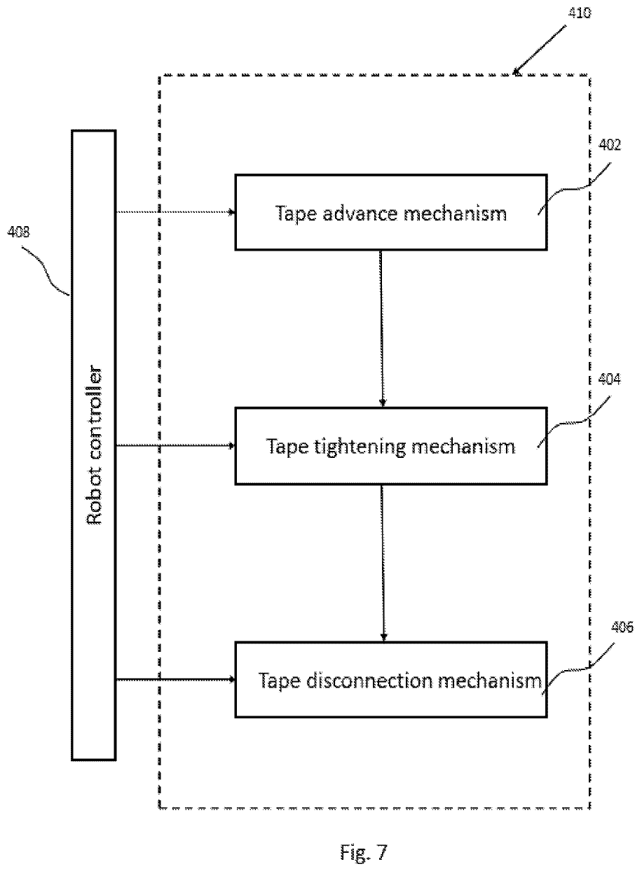

FIG. 7 illustrates in a block diagram form the general structure 410 of the gripper of the invention. The gripper includes a tape advance mechanism 402, a tape tightening mechanism 404, and a tape disconnection mechanism 406. All these mechanisms are contained within the gripper's casing. They are controlled by the robot controller 408, typically located outside the gripper's case, for example, within the robot's arm.

The tape advance mechanism 402 generally includes the supplying and receiving axles 234 and 236, respectively, and servo motor 244. The tape tightening mechanism 404 generally includes the central piston 232 and the bottom pad 258. The tape disconnection mechanism 406 generally consists of the two side pistons 246 and 248 and the peripheral (disconnecting) frame 238. The detailed structure of each of these mechanisms has been described above.

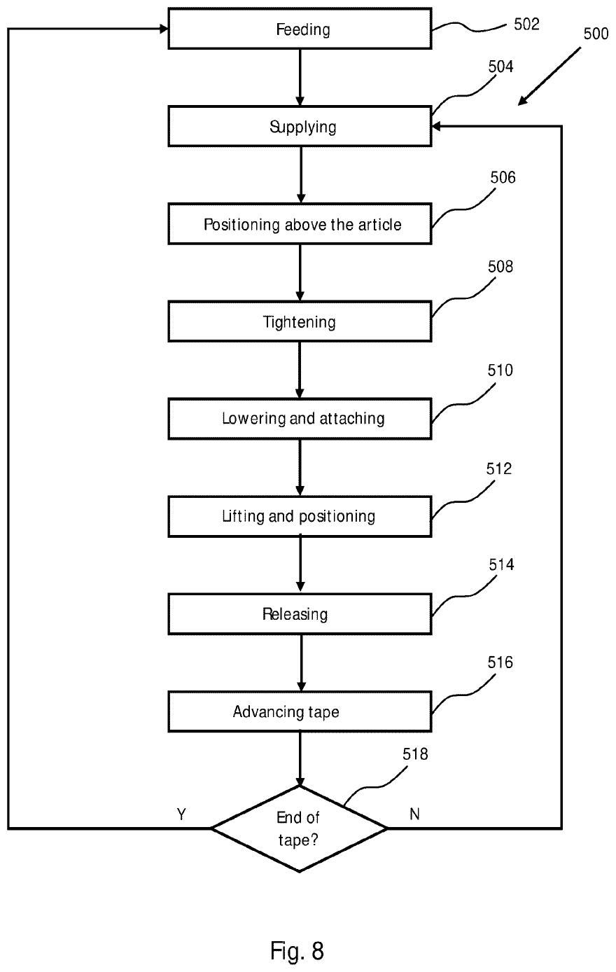

FIG. 8 illustrates in a flow diagram form a general procedure 500 for operating a robot arm with the gripper 200 of the invention. In the feeding stage 502, a bobbin with adhesive tape is placed within a tape course, as shown in FIG. 5a. Next, in stage 504 (and assuming that the gripper is already attached to the robot's arm), a supply of air and electricity is activated from the arm to gripper 200. In stage 506, the robot's arm positions the gripper above the article, for example, 40 cm above the center of gravity of the article. In stage 508, the tape is tightened by activating the central piston 232. In stage 510, the arm is lowered, so the pad and tape 214 are attached to the article. In stage 512, the arm lifts the article (attached to the gripper 200) and positions it at a target position, for example, within an open box. In stage 514, the disconnection mechanism is activated (for example, by supplying air pressure to the two side pistons 246 and 248) to release the article at the target location. At this stage, the task has been completed. In stage 516, a signal is provided to the servo motor to advance tape 214. In stage 518, if the tape bobbin has reached its end (“Y” sensed by a suitable sensor-not shown), the procedure returns to stage 502 for a tape replacement and a new cycle of article handling (i.e., lifting and positioning). Otherwise, the servo motor advances the tape, and the procedure is repeated for a new article, beginning from stage 504. Again, in some embodiments, the advance of the tape may be performed once every several (e.g., one, two, . . . etc.) particle lifting tasks.

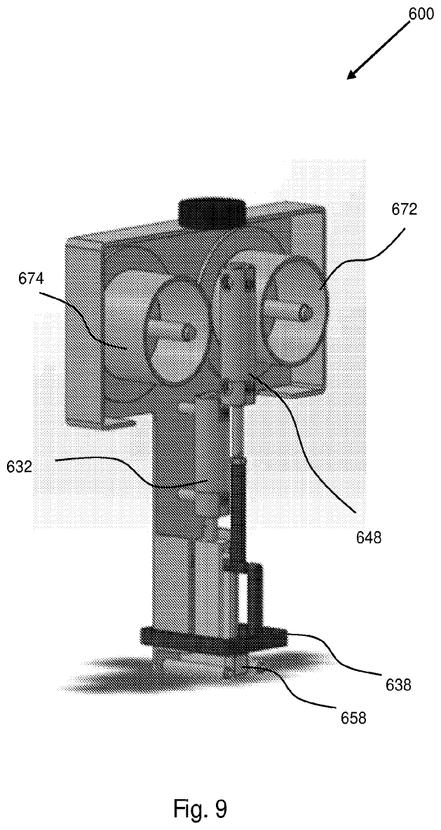

FIG. 9 generally illustrates a structure of a second embodiment 600 of the gripper of the invention. The gripper's structure 600 is somewhat similar to the structure of gripper 200. The gripper includes a supplying tape bobbin 672 positioned on a supplying axle and a receiving tape bobbin 674 placed on a receiving axle. The two axles (and respective bobbins) are located one next to the other. Furthermore, the gripper includes a peripheral frame 638, bottom pad 658, central piston 632, and one frame driving piston 648, used to drive the peripheral frame 638.

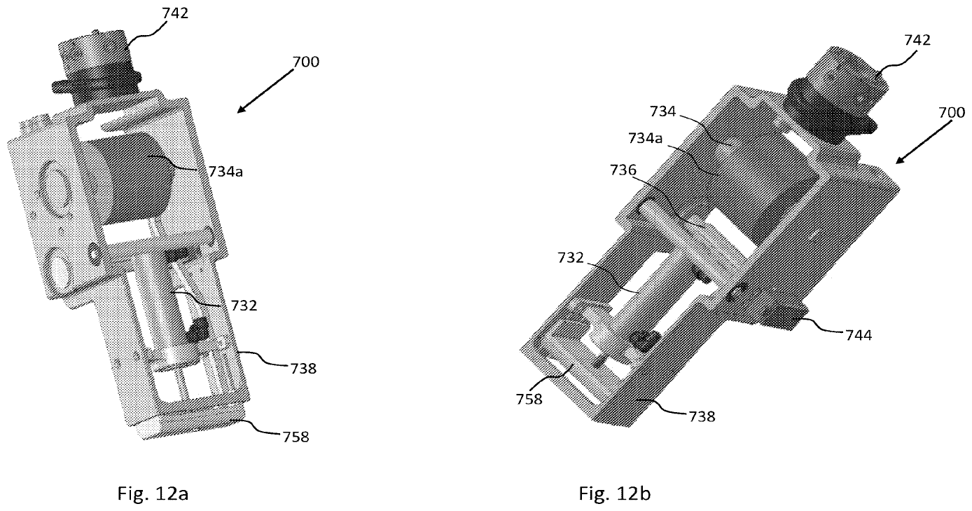

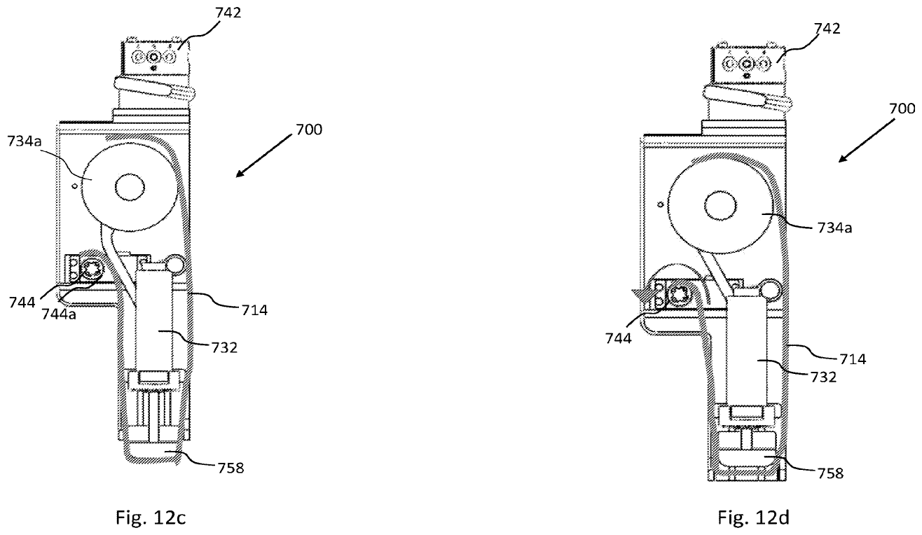

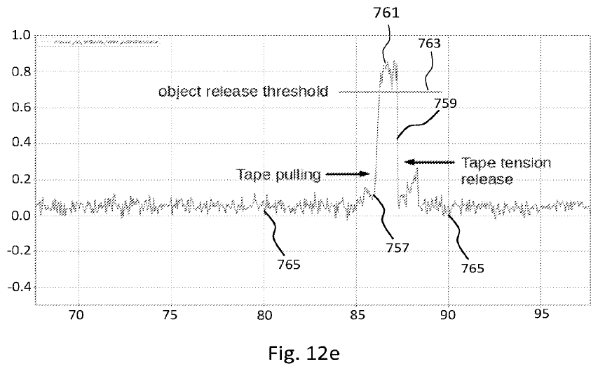

FIGS. 12a to 12d generally illustrate a structure of a third embodiment 700 of the gripper of the invention. FIGS. 12a and 12b show the structure of gripper 700 in extended and retracted states, respectively. FIGS. 12c and 12d also show the structure of gripper 700 in extended and retracted states, respectively, however, while including the adhesive tape 714. The structure of gripper 700 is similar to the structure of the first embodiment's gripper 200, and like numbers represent like components. For the sake of brevity, only differences between the two embodiments are elaborated herein. There are two main differences between the two embodiments, as follows: (a) While gripper 200 includes a movable frame 238 (used to disconnect the product at the destination), frame 738 of the gripper 700 is stationary; therefore, the two side pistons 246 and 248 are eliminated from gripper 700 which includes only a single central piston; and (b) While in gripper 200 the pad 258 remains stationary during the disconnection stage (only the frame 238 extends downwards), in gripper 700 the piston retracts during the disconnection stage, elevating the pad 758 within the grippers' 700 casing.

The operation of gripper 700 is now described in more detail. (a) Initially, piston 732 is in its retracted state as shown in FIG. 12d; (b) Motor 744 rotates counterclockwise, thereby “collecting” a sufficient s length of refreshed tape 714 on bobbin 744a; (c) Motor 744 then rotates clockwise, such that the tape “goes down”, releasing contact from pad 758; (d) Next, piston 732 moves down to its extended state, bringing the gripper to its operational state, while pad 758 and the tape 714 are as shown in FIG. 12c. at this state, the gripper is ready for sticking to a product. The robot “grips” a product using the tape adhesion at the pad's 758 section and moves it to a destination; (e) Next, piston 732 moves up to its retracted state, shown in FIG. 12d. Tape 714 is not yet necessarily separated from the product (i.e., remains down); (f) Next, motor 744 “pulls” the tape 714, bringing it to the state of the tape and pad shown in FIG. 758. This pulling action first separates tape 714 from the product. Then, the motor 744 optionally somewhat continues in pulling tape 714 from bobbin 734a to obtain a “refreshed” section of adhesive tape below pad 758; and (f). The operation repeats from step (c) with a new product.

The gripper may utilize an ampere meter, connected in series to motor 744, to sense various states of tape 734. FIG. 12e shows the ampere meter measurements. In point 757, motor 744 begins pulling the tape (counterclockwise rotation in FIG. 12c). Level 763 indicates where the separation from the product occurs (this level may be determined using empirical tests). Region 759, where the current drops, shows the tape's release (clockwise rotation in FIG. 12c). Finally, regions 765 are regions where the motor is inactive.

Fourth Embodiment: The gripper of the first and second embodiments described above includes a release (disconnection) mechanism intended to release the article from the tape upon arrival at the destination. For example, in the first embodiment, this mechanism includes the peripheral frame 238 and the two side pistons 246 and 248. According to the Fourth embodiment, The gripper has no dedicated release mechanism. When a release of the article becomes necessary, the release is performed in one of the following manners: (a) manipulating the arm and bringing the gripper and attached article to impact another rigid object (such as the box, table surface, etc.). If appropriately performed, this impact disconnects the article; and (b) advancing the tape by servo motor 244. The advance of the tape releases the attached article. This latter manner is somewhat wasteful in tape material, as it requires release and refreshment of the tape upon each robot operation.

Fifth Embodiment: The gripper may include two servo motors. After exhausting the tape's entire length by operation of the first motor, the advancing direction of the tape is reversed by deactivating the first motor and activating the second servo motor to advance the tape. In such a structure and manner of operation, the roles of the accumulating and supplying bobbins are alternated.

sixth Embodiment: The gripper may include a glue container, which may be used to refresh the adhesivity of the tape when necessary. When refreshment of the tape becomes necessary, the tape is successively immersed in the glue. This gripper structure may include two motors, as in the Fifth Embodiment.

The entire robot system may include several commonly known sub-systems that are not within the scope of the invention, such as:
a. A sub-system for selecting the most suitable gripper for a given article;
b. A sub-system for detecting the most suitable location for gripper-article engagement;
c. Optionally, a sub-system for determining where to position the article within a given box (that in itself may be capable of containing several articles);
d. A sub-system for operating the adhesive-tape gripper of the invention;
e. Etc.

### EXAMPLE

The inventors built a gripper according to the above-described structure (particularly FIGS. 5a-5i). A robot's arm, model number IRB-1200-07-7 manufactured by ABB, was used. The gripper included the following components:
A 6V, up to 20 W servo motor, model number SPT5525LV, manufactured by KG Digital Servo25;
A small-size air-driven central piston, model number N1A16B1014, 14 mm diameter;
Two side air-driven pistons model number N1A12A04016, 16 mm diameter;
A 12.50 m tape having 50 mm width was used, where the length of the bottom pad was 25 mm;
Two types of tapes were used: (a) a transparent tape manufactured by Gorila, and a golden-color tape manufactured by Golden Tape. A single roll of tape (12.50 m) was found sufficient for about 1000 lifts (depending on the frequency of tape advancements);
A 5Bar air pressure was supplied to the adapter from the arm;

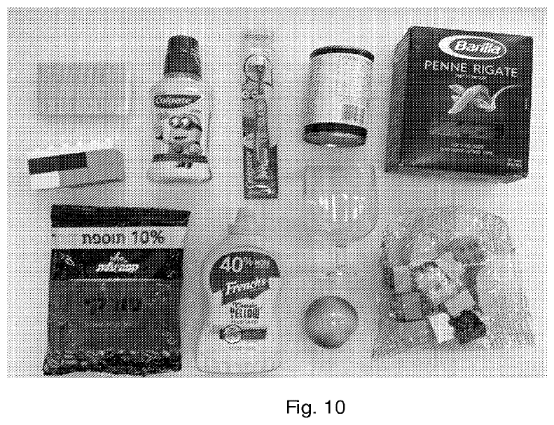

FIG. 10 shows several of the articles successfully lifted by the gripper of the invention. Articles up to 2 Kg of weight (depending on the article's material) were successfully lifted. Several interesting articles that have been successfully lifted were: cleaning (scouring) Scotch pads, fabric articles, and articles having complicated geometries, such as vegetable peelers, garlic crushers, conventional cardboard boxes, and more. A success rate of over 90% was obtained in the experiments.

FIGS. 11a to 11f show the gripper of the invention during operation while lifting a variety of articles.

While some embodiments of the invention have been described by way of illustration, it will be apparent that the invention can be carried into practice with many modifications, variations, and adaptations and with the use of numerous equivalent or alternative solutions that are within the scope of persons skilled in the art, without departing from the spirit of the invention or exceeding the scope of the claims.

1. An adhesive-based tool gripper for a robot, comprising:
(a) a supplying axle configured to mount a supplying bobbin of adhesive tape;
(b) a receiving axle configured to mount a tape-receiving bobbin;
(c) a bottom pad;
(d) a tape course within the tool gripper beginning at said supplying bobbin, passing below said bottom pad, while an adhesive side of the tape faces down, and ending at said receiving bobbin; and
(e) a tape advance mechanism configured to advance the tape, thereby refreshing a tape section below said bottom pad.

2. The tool gripper of claim 1, further comprising a disconnecting mechanism configured to push an article attached to said tape section away from the bottom pad.

3. The tool gripper of claim 1, further comprisinga locking mechanism for the receiving axle.

4. The tool gripper of claim 1, further comprisinga locking mechanism for both the receiving axle and the supplying axle.

5. The tool gripper of claim 1 further comprising an adapter that is configured for attachment to a robot arm;

6. The tool gripper of claim 1, wherein said tape-advance mechanism is selected from a servo motor or a rotating piston.

7. The tool gripper of claim 2, wherein said disconnecting mechanism comprising:
(a) a moveable peripheral frame enveloping said bottom pad; and
(b) one or more side pistons configured to either push the peripheral frame distally-in a direction away from an arm of the robot, or retract it proximally.

8. The tool gripper of claim 2, wherein said disconnecting mechanism comprising:
(c) a stationary peripheral frame enveloping said bottom pad; and
(d) a central piston configured to either push the bottom pad distally-in a direction away from an arm of the robot, or retract it proximally.

9. The tool gripper of claim 7, wherein said side pistons are selected from linear pistons, rotary pistons, linear actuators or linear motors, spring-retracted pistons, or air-driven pistons.

10. The tool gripper of claim 1, further comprising a tape tightening mechanism configured to tighten the bottom pad against said tape section.

11. The tool gripper of claim 10, wherein said tape tightening mechanism comprising a central piston, configured to push the bottom pad distally, at a direction away from an arm of the robot to which the gripper is installed.

12. The tool gripper of claim 10, wherein said central piston is a spring retracted piston, or a passive spring.

13. The tool gripper of claim 11, wherein said central piston is attached to a locking mechanism configured to lock a rotation of said supplying axle, simultaneously with said distal push of the bottom pad.

14. The tool gripper of claim 5, wherein said adapter is configured to receive controlled air supply and/or electricity from a robot's arm and is further configured to convey said air and/or electricity to components within the adhesive tool gripper.

15. The tool gripper of claim 14, wherein said air and/or electricity are controlled by a robot's controller.

16. The tool gripper of claim 1, wherein said advance of the tape is further used to disconnect an article attached to the tape.

17. A method for operating an adhesive-based robot controller, comprising:
(a) providing an adhesive-based tool gripper comprising a casing;
(b) providing a bottom pad within said casing;
(c) further providing within the casing a supplying tape axle and a receiving tape axle;
(d) mounting on each said axles a supplying tape bobbin and a receiving tape bobbin, respectively, and positioning the adhesive tape such that it begins in said supplying tape bobbin, passes below said bottom pad, and ends at said receiving tape bobbin;
(e) joining the tool gripper to a robot's arm;
(f) directing the arm towards an article, attaching a tape section below said bottom pad to the article, lifting the article, positioning the article at a desired location, and releasing the article; and
(g) advancing the tape to locate a refreshed tape section below said bottom pad and repeating the procedure from the directing step.

18. The method of claim 17, further comprising a replacement of the supplying tape bobbin upon reaching an end of the tape.
